(19) United States
(12) Patent Application Publication
(10) Pub. No.: US 2010/0110403 A1
(43) Pub. Date: May 6, 2010

(54) MEASUREMENT APPARATUS, EXPOSURE APPARATUS, AND DEVICE MANUFACTURING METHOD

(75) Inventor: Makiko Ogasawara, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/608,771

(22) Filed: Oct. 29, 2009

(30) Foreign Application Priority Data
Oct. 31, 2008 (JP) 2008-282435

(51) Int. Cl. G03B 27/68; G01B 9/00

(52) U.S. Cl. 355/55; 356/124; 355/77

(57) ABSTRACT

A measurement apparatus for measuring wavefront aberration of an optical system to be measured comprises a pinhole mask having a pinhole, an illumination optical system configured to illuminate the pinhole mask, a test pattern disposed between the pinhole mask and the optical system to be measured, a detector configured to detect an image formed on an image plane of the optical system to be measured by light having passed through the pinhole, the test pattern, and the optical system to be measured, and an optical member which is disposed or inserted in the illumination optical system, and configured to control an illuminance distribution in a pupil region of the optical system to be measured so that a peripheral portion in the pupil region includes a portion having an illuminance higher than an illuminance in a central portion in the pupil region.

### BACKGROUND OF THE INVENTION

1. Field of the Invention

The present invention relates to a measurement apparatus for measuring the wavefront aberration of an optical system, an exposure apparatus including the measurement apparatus, and a method of manufacturing a device using the exposure apparatus.

2. Description of the Related Art

An exposure apparatus is used to manufacture devices such as a semiconductor device, a display device, and a magnetic head device. The exposure apparatus projects the pattern of a reticle onto a substrate (e.g., a wafer or a glass plate) by a projection optical system to expose the substrate.

The exposure apparatus should precisely project the pattern of a reticle onto a substrate at a predetermined magnification. To meet this condition, it is important to minimize the aberration of the projection optical system. This is especially because, as micropatterning of devices advances in recent years, the pattern quality becomes sensitive to the aberration of the projection optical system. Again, as micropatterning of devices advances, the NA of the projection optical system increases. Under the circumstances, it is demanded to measure the optical characteristics (aberrations) of a high-NA projection optical system with high accuracy.

At present, the wavefront aberration of a projection optical system is often measured for evaluation of the projection optical system. It is possible to calculate aberrations such as spherical aberration, field curvature, astigmatism, and coma that are factors of wavefront aberration by approximating the wavefront aberration by Zernike polynomials. Importance is again attached to wavefront aberration measurement in order to predict the process margins in a wide variety of patterns by simulation. The wavefront aberration of a projection optical system can be measured by applying, for example, the Shack-Hartmann principle (International Publication No. 03/021352).

FIG. 14 is a view for explaining a method of measuring the wavefront aberration of a projection optical system in an exposure apparatus (SPIN method). A test reticle 1000A has a test pattern (pattern group) 1100A formed on its one surface, and a pinhole 1200A formed in its opposite surface. Beams of illumination light with an illumination angle that satisfies σ>1 or σ=1 illuminate the pinhole 1200A, pass through the pinhole 1200A, and emerge from the test pattern 1100A. These light beams have different angles of divergence. σ is given by (the NA of illumination light)/(the NA of a projection optical system). These light beams further pass through different positions on a pupil plane 2100 of a projection optical system 2000, are subjected to the wavefront aberration of the projection optical system 2000, and reach an image plane 3000. Patterns (image) TPI formed on the image plane 3000 are subjected to different wavefront aberrations (phases). That is, because the light beams travel in the normal direction to the wavefront, the patterns TPI formed on the image plane 3000 shift depending on the amounts of tilt of the wavefront. The amounts of positional shift of the patterns TPI, thus formed on the image plane 3000, from reference positions are respectively measured at a plurality of points. The wavefront aberration of the projection optical system 2000 can be calculated based on the wavefront tilts corresponding to the measured amounts of positional shift.

To measure the wavefront aberration over the entire pupil region of an optical system (projection optical system) using wavefront aberration measurement as mentioned above, the light to the peripheral (edge) portion (the vicinity of a position corresponding to σ=1) in the pupil region is to be guided as well.

If the intensity of light which enters the pupil region of the optical system to be measured (measured optical system) is not uniform, this leads to line width nonuniformity and a decrease in contrast in an image formed on the image plane. In general, the position of an image formed on the image plane is calculated by detecting the edge of the image. Line width nonuniformity inevitably causes a measurement error that depends on the measurement position, and a decrease in contrast degrades the edge detection accuracy.

U.S. Pat. No. 7,283,202 discloses a method of disposing an optical member in an illumination optical system in order to obtain incident light over a wide range. This method can obtain light over a wide range by disposing an optical member such as a diffusing plate or a stop in an illumination optical system.

Japanese Patent Laid-Open No. 2006-080444 discloses a method of disposing a binary optics on a test reticle, and illuminating the test pattern by the binary optics, thereby measuring the wavefront aberration of an optical system.

Unfortunately, the method disclosed in U.S. Pat. No. 7,283,202 lowers the intensity of light which strikes the peripheral portion in the pupil region of a projection optical system. This is because a σ stop of the illumination optical system shields light with an illumination angle that satisfies σ>1. Furthermore, there exist parameters, such as the cosine fourth law, the pupil transmittance distribution, and the resist reflectance, which account for illuminance attenuation along with an increase in angle of a light beam with respect to the optical axis. These parameters naturally account for a decrease in contrast of an image formed on the image plane by light which reaches the image plane upon passing through the peripheral portion in the pupil region. As the NA of the projection optical system increases, the incident angle on the test pattern, in turn, increases. In the future, this trend may lead to a further decrease in contrast of an image formed on the image plane by a light beam which reaches the image plane upon passing through the peripheral portion in the pupil region.

The invention described in Japanese Patent Laid-Open No. 2006-080444 merely determines the angle of light which illuminates a test pattern by a binary optics. In this respect, Japanese Patent Laid-Open No. 2006-080444 is irrelevant to increasing the intensity of light which strikes the peripheral portion in the pupil region of the measured optical system.

### SUMMARY OF THE INVENTION

One of the features of the present invention provides an measurement apparatus for measuring wavefront aberration of an optical system to be measured, the apparatus comprising a pinhole mask having a pinhole, an illumination optical system configured to illuminate the pinhole mask, a test pattern disposed between the pinhole mask and the measured optical system, a detector configured to detect an image formed on an image plane of the optical system to be measured by light having passed through the pinhole, the test pattern, and the optical system to be measured, and an optical member which is disposed or inserted in the illumination optical system, and configured to control an illuminance distribution in a pupil region of the optical system to be measured so that a peripheral portion in the pupil region includes a portion having an illuminance higher than an illuminance in a central portion in the pupil region.

Further features of the present invention will become apparent from the following description of exemplary embodiments with reference to the attached drawings.

### BRIEF DESCRIPTION OF THE DRAWINGS

FIG. 1 is a view showing the schematic arrangement of an exposure apparatus or a measurement apparatus according to the first embodiment of the present invention;

FIGS. 2A and 2B are views illustrating test patterns;

FIG. 3 is a view illustrating a test pattern;

FIG. 4 is a view showing the schematic arrangement of an exposure apparatus or a measurement apparatus according to the second embodiment of the present invention;

FIGS. 5A and 5B are graphs illustrating illuminance distributions formed by first and second optical members;

FIGS. 6A and 6B are graphs showing h(x, y) formed on the image plane using f(x, y) and g(x, y) shown in FIGS. 5A and 5B;

FIG. 7 is a view showing the arrangement of an exposure apparatus or a measurement apparatus according to an embodiment of the present invention;

FIG. 8 is a flowchart showing details of an illumination condition optimization process in step S111 of FIG. 10;

FIG. 9 is a graph for explaining illuminance distribution optimization;

FIG. 10 is a flowchart showing a wavefront aberration measurement method;

FIG. 11 is a flowchart showing a control method for an exposure apparatus according to an embodiment of the present invention;

FIG. 12 is a graph showing a reference example of the illuminance distribution on the image plane of an optical system;

FIG. 13 is a diagram showing the concept of a measurement region; and

FIG. 14 is a view for explaining a method of measuring the wavefront aberration of a projection optical system in an exposure apparatus.

### DESCRIPTION OF THE EMBODIMENTS

Embodiments of the present invention will be described below with reference to the accompanying drawings. Note that the same reference numerals denote the same constituent elements throughout the accompanying drawings.

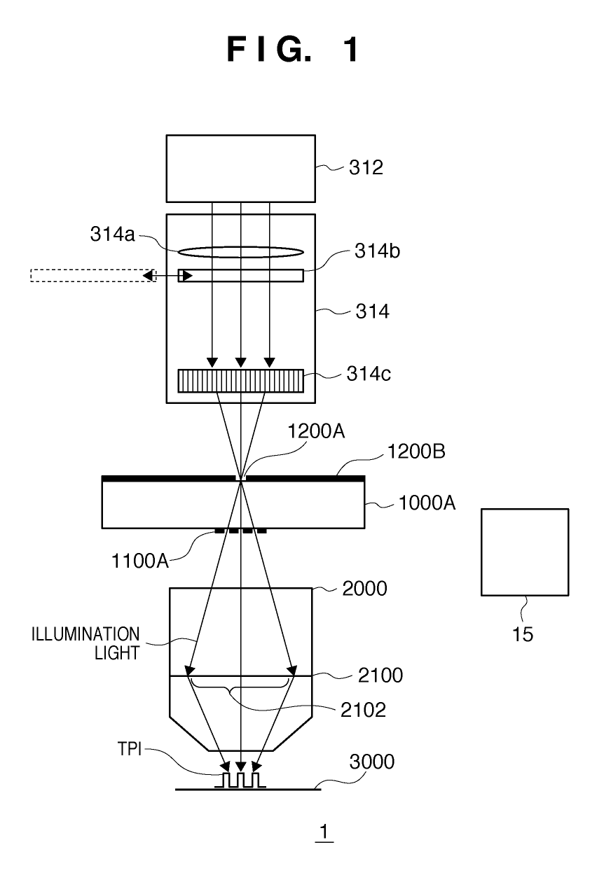

FIG. 1 is a view showing the schematic arrangement of an exposure apparatus or a measurement apparatus according to a first embodiment of the present invention. The exposure apparatus according to the first embodiment of the present invention is configured to project the pattern of a reticle onto a substrate (e.g., a wafer or a glass plate), coated with a photoresist (photosensitive material), by a projection optical system 2000 to expose the photoresist. A latent image is formed on the photoresist by pattern projection. A resist pattern is formed by developing the photoresist. An exposure apparatus 1 includes a measurement apparatus for measuring the wavefront aberration of an optical system assuming that the projection optical system 2000 is the optical system to be measured.

The exposure apparatus (measurement apparatus) 1 includes a light source 312, an illumination optical system 314, and the projection optical system 2000. The illumination optical system 314 illuminates a test reticle 1000A or a reticle for device manufacture with light supplied from the light source 312. The projection optical system 2000 projects the pattern of a reticle onto a substrate. The exposure apparatus (measurement apparatus) 1 can further include a reticle stage which holds the test reticle 1000A or the reticle for device manufacture, and a substrate stage which holds the substrate. The test reticle 1000A is generally fixed on the reticle stage in measuring the wavefront aberration of the projection optical system 2000 as the measured optical system. The test reticle 1000A has a first surface on which a test pattern 1100A is formed, and a second surface on which a pinhole mask 1200B is formed. The test pattern 1100A includes a plurality of patterns TPb. The pinhole mask 1200B has a pinhole 1200A formed in a light-shielding film. The test pattern 1100A and pinhole mask 1200B may be formed on separate members.

FIG. 10 is a flowchart showing a method of measuring the wavefront aberration of the projection optical system (measured optical system) 2000 in the exposure apparatus or the measurement apparatus according to the first embodiment of the present invention, illustrated in FIG. 1. A wavefront aberration measurement method by the SPIN method will be exemplified herein. In this embodiment, a controller 15 included in the exposure apparatus 1 controls the execution of the measurement method shown in FIG. 10.

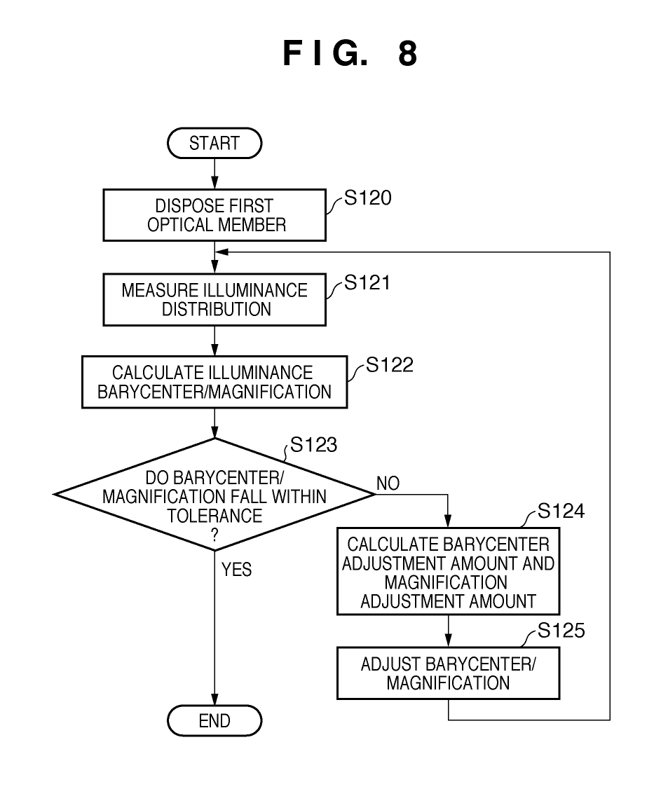

In step S111 (e.g., illumination condition optimization), the illuminance distribution is optimized. Details of step S111 will be described later with reference to FIG. 8. In step S112 (e.g., load test reticle), the test reticle 1000A is fixed on the reticle stage.

In step S113 (e.g., perform illumination), an entire pupil region 2102 on a pupil plane 2100 of the projection optical system 2000 is illuminated with light having passed through the pinhole 1200A and test pattern 1100A while an optical member 314b is disposed or inserted in the optical path of the illumination optical system 314 (the optical member 314b is inserted into the optical path of the illumination optical system 314 in step S111). This light passes through the pupil region 2102 in the time interval from its incidence on the projection optical system 2000 until its emergence from the projection optical system 2000. Beams of this light travel in the normal direction to the wavefront aberration of the projection optical system 2000, again, in the time interval from its incidence on the projection optical system 2000 until its emergence from the projection optical system 2000 (during its passage through the projection optical system 2000). As a consequence, an image (light intensity distribution) which bears the information of the wavefront aberration of the projection optical system 2000 is formed on an image plane 3000 of the projection optical system 2000 by light having passed through the pinhole 1200A, test pattern 1100A, and projection optical system 2000. The optical member 314b controls the illuminance distribution in the pupil region of the projection optical system 2000 as the measured optical system so that the peripheral (edge) portion (the vicinity of a position corresponding to σ=1) in the pupil region includes a portion having an illuminance higher than that in the central portion in the pupil region.

In step S114 (e.g., measure image positional shift), the amounts of positional shift of a plurality of patterns TPI, included in the image formed on the image plane 3000, from reference positions are measured. This measurement can be performed by detecting the image formed on the image plane 3000. Alternatively, this measurement can be performed by disposing a substrate coated with a photoresist on the image plane 3000, exposing the substrate to light to form a latent image on it, and observing the latent image, or developing the photoresist to form a resist pattern on it, and observing the resist pattern. In step S115 (e.g., calculate wavefront aberration), the wavefront aberration of the projection optical system 2000 can be obtained by processing the obtained measurement result in accordance with a processing method as described in PCT(WO) 03/088329.

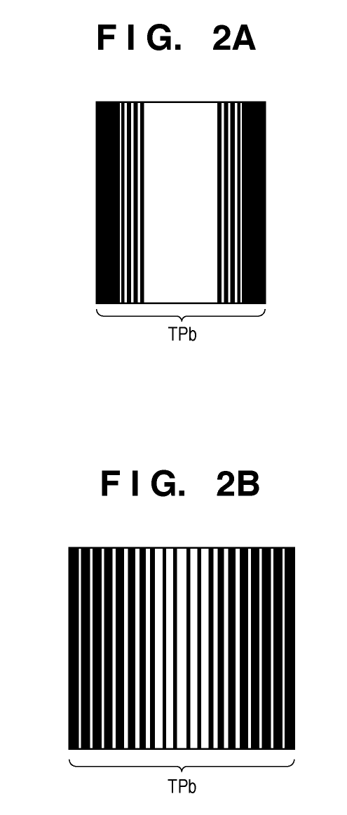

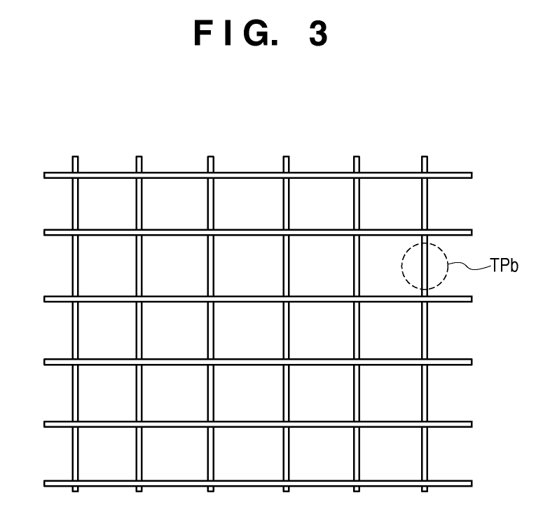

The pattern TPb which constitutes the test pattern 1100A can include an opening portion and line-and-space patterns disposed on two sides of the opening portion, as illustrated in FIG. 2A. Alternatively, the pattern TPb which constitutes the test pattern 1100A can include a line-and-space pattern having a constant pitch between lines or spaces and a space width which gradually narrows from the central portion toward the peripheral portion, as illustrated in FIG. 2B. Or again, the pattern TPb which constitutes the test pattern 1100A can include a pattern having a thin line interposed between two sides of each thick line. PCT(WO) 03/088329 describes such a test pattern. The pattern TPb can be macroscopically regarded as one large pattern in which spaces between lines are narrow enough not to resolve them and which has small distortion. The test pattern 1100A can be formed by arraying such patterns TPb in a grid pattern, as illustrated in FIG. 3.

In the SPIN method, the positional shift sensitivity (the sensitivity to the aberration of the projection optical system 2000) of the pattern TPI, formed on the image plane 3000 of the projection optical system 2000 by light having passed through the peripheral portion within the pupil region 2102 of the projection optical system 2000, is relatively high. In view of this, the measurement accuracy of the wavefront aberration of the projection optical system 2000 improves by accurately measuring a positional shift of the pattern TPI formed by light having passed through the peripheral portion within the pupil region 2102 of the projection optical system 2000. Therefore the illuminance in the peripheral portion within the pupil region 2102 of the projection optical system 2000 is to be increased.

Especially to transfer an image of the pattern TPb onto a photoresist on a substrate as a latent image and observe the latent image, a difference Δ between the maximum and minimum values of an illuminance distribution h(x, y) in the measurement range of the image plane 3000 should fall within 30% of the maximum value, according to inventor's experience. Such a condition will be referred to as a target illumination condition hereinafter. The illumination optical system 314 illuminates the test pattern 1100A with an illuminance distribution which satisfies a target illumination condition while the optical member 314b is disposed in the optical path of the illumination optical system 314.

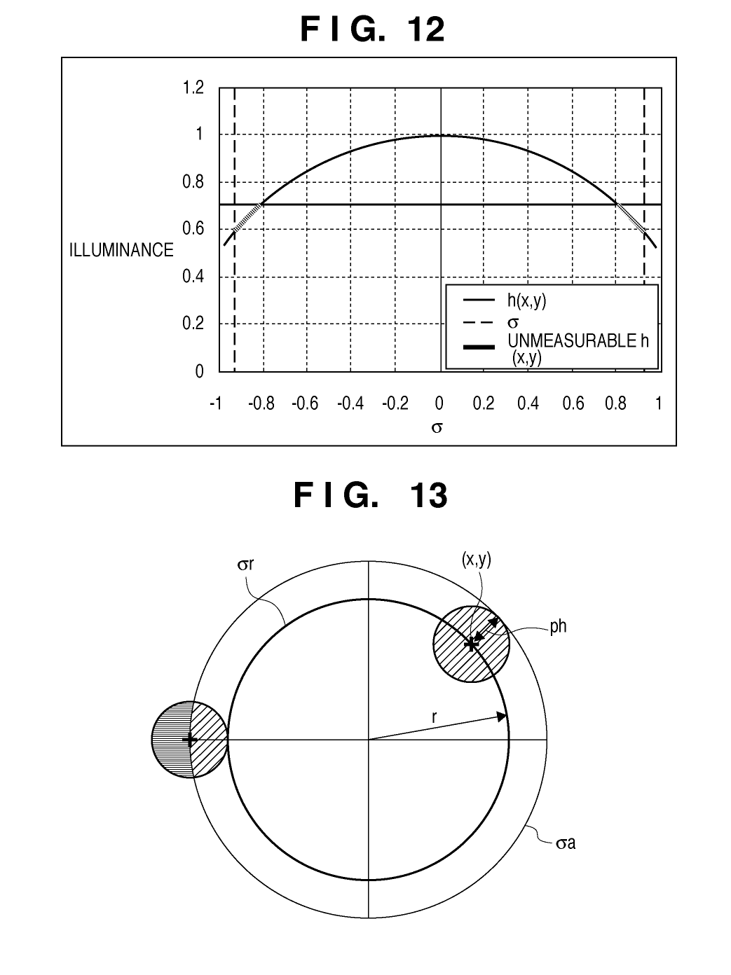

FIG. 12 is a graph showing, as a reference example, an illuminance distribution h(x, y) on the image plane 3000 when a test reticle having a diffusing plate attached to it is disposed on the object plane of the projection optical system 2000 and is illuminated under an illumination condition of σ=0.9. Note that in FIG. 12, the ordinate indicates the illuminance normalized using the illuminance when σ=0.

h(x, y) indicated by a bold line is a portion which corresponds to the peripheral portion within the pupil region and therefore cannot satisfy a target illumination condition. In this portion, a low-contrast image is formed or no image is formed on the substrate, so the wavefront aberration measurement accuracy is relatively low.

A method of designing the optical member 314b disposed or inserted in the optical path of the illumination optical system 314 in measuring the wavefront aberration of the projection optical system 2000 will be explained below. For the sake of descriptive simplicity, the illumination optical system 314 is assumed herein to include a condenser lens 314a and fly-eye lens 314c. Also, the fly-eye lens 314c is assumed herein to be inserted in the optical path of the illumination optical system 314 in measuring the wavefront aberration of the projection optical system 2000. However, an actual illumination optical system 314 can include a larger number of optical elements.

First, light emitted by the light source 312 strikes the optical member 314b after passing through the condenser lens 314a, and forms an illuminance distribution f(x, y) by the optical member 314b. The moment light which forms an illuminance distribution f(x, y) passes through the fly-eye lens 314c, the illuminance decreases by an amount corresponding to the transmittance of the fly-eye lens 314c.

The light emerging from the illumination optical system 314 illuminates the pinhole mask 1200B having the pinhole 1200A. The light having passed through the pinhole 1200A, in turn, illuminates the test pattern 1100A. The illuminance decreases in accordance with the cosine fourth law of an angle θ between the pinhole 1200A and the test pattern 1100A.

The light emerging from the test pattern 1100A enters the projection optical system (measured optical system) 2000, and the illuminance decreases in accordance with a pupil transmittance distribution p(x, y) of the projection optical system 2000. The light emerging from the projection optical system 2000 forms an image which bears the information of the aberration of the projection optical system 2000 on the image plane 3000. This image includes the patterns TPI.

The illuminance distribution h(x, y) on the image plane 3000 is given by:

h(x,y)=(f(x,y)·fy(x,y))*ph(x,y)·p(x,y)·rs(x,y)·cos⁴θ (1)

where f(x, y) is the illuminance distribution formed by the optical member 314b; fy(x, y) is the transmittance distribution of the fly-eye lens 314c; ph(x, y) is a function describing the characteristic of the pinhole 1200A; h(x, y) is the illuminance distribution on the image plane 3000; p(x, y) is the pupil transmittance distribution of the projection optical system 2000; rs(x, y) is the resist reflectance (rs(x, y) is taken into consideration only when the test pattern is transferred onto the resist); (x, y) are the coordinates obtained by converting a coordinate system defined by the position assuming the optical axis as the origin is converted into that defined by the σ value; θ is the angle between the optical axis and the light beam; and * is a convolution (convolution calculation) symbol.

In exposing a substrate to manufacture a device, light beams with different illumination angles obliquely reach a certain point in the object plane. Then, the sum of their illuminances is determined as the illuminance at the certain point. In contrast, in the SPIN measurement method, only light with an illumination angle determined based on the positional relationship between the pinhole 1200A and a certain point in the object plane obliquely reaches the certain point. Then, the illuminance at the certain point is determined by that obliquely incident light alone.

Hence, a uniform illuminance on the image plane in the SPIN measurement method amounts to be a uniform intensity of obliquely incident light.

According to one method, an illuminance distribution h_{ideal} (x, y) which satisfies a target illumination condition is substituted into the left side of equation (1), fy(x, y), ph(x, y), p(x, y), and rs(x, y) are substituted into its right side, and deconvolution (restoration calculation) is performed. With this operation, f_{ideal}(x, y) can be obtained as an ideal f(x, y). Note that f_{ideal}(x, y) can be an illuminance distribution in which the peripheral portion in the pupil region of the projection optical system 2000 includes a portion having an illuminance higher than that in the central portion in the pupil region. Alternatively, f_{ideal} (x, y) can be an illuminance distribution having a peak in the peripheral portion in the pupil region of the projection optical system 2000.

According to another method, an illuminance distribution h(x, y) is calculated while changing f(x, y) within a practically possible range of values in equation (1), thereby determining f(x, y) with which the illuminance distribution h(x, y) satisfies a target illumination condition.

The optical member 314b can include, for example, a binary optics (e.g., a CGH) so as to form the determined f_{ideal} (x, y). h_{ideal}(x, y) can be implemented using the thus fabricated optical member 314b.

Moreover, executing the SPIN method using the optical member 314b makes it possible to obtain patterns TPI at respective points with a uniform illuminance distribution over a wide range. This allows aberration measurement with high accuracy.

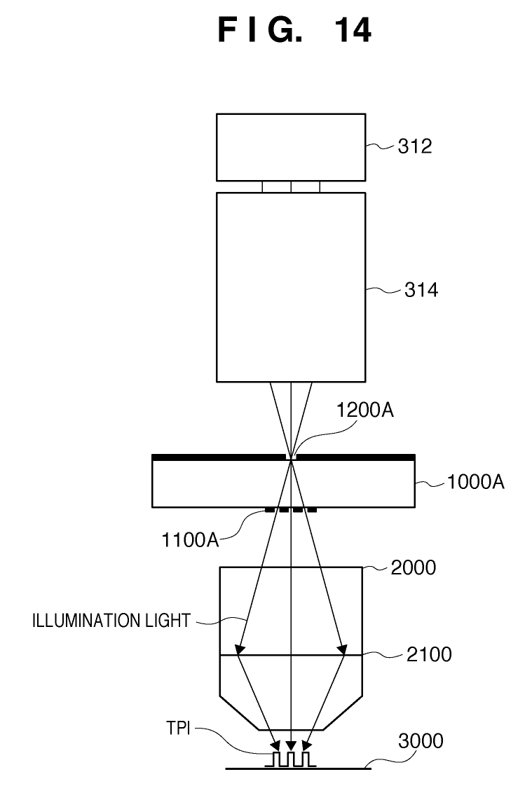

A measurement region to calculate the wavefront aberration of an optical system such as a projection optical system by the SPIN method will be explained hereinafter. FIG. 13 is a diagram showing the concept of a measurement region. The SPIN method uses a pinhole having a certain size, and therefore obtains each measurement data as the average of the wavefront aberrations in a region extending over an area equal to the pinhole diameter on the pupil plane of the projection optical system.

Let σa be the range across which measurement for wavefront aberration calculation is performed. Then, the measurement data obtained at each measurement point (x, y) in the peripheral portion falling within σa bears the information of a part of the measurement region, which extends over an area equal to the pinhole diameter in excess of the range σa. To avoid this, the measurement values obtained in the peripheral portion is not used for wavefront aberration calculation.

A maximum distance σr from the pupil center, which can be used for wavefront aberration calculation, is given by:

σa≦σr=1−ph (2)

where ph is the pinhole diameter converted into a σ value.

A second embodiment of the present invention will be described below. Note that details which are not particularly referred to in the second embodiment can be the same as in the first embodiment.

It is difficult to fabricate an optical member 314b so as to perfectly uniform the transmittance distribution of a fly-eye lens 314c. For this reason, local illuminance nonuniformity may occur on the image plane. As described above, illuminance nonuniformity adversely affects the line width of a pattern TPIa formed on the image plane of an optical system such as a projection optical system. Under this adverse influence, the edge detection accuracy in measuring positional shifts of patterns TPI degrades, and the positional shift measurement accuracy, in turn, degrades. This results in degradation in the measurement accuracy of the wavefront aberration of the measured optical system.

To combat this situation, in the second embodiment, illuminance nonuniformity (nonuniformity of the transmittance distribution of the fly-eye lens 314c) is reduced using a second optical member 500, in addition to the optical member (first optical member) 314b. The second optical member 500 is to be disposed between an illumination optical system 314 and the exit of a pinhole mask 1200B. The second optical member 500 should be disposed, for example, near the pinhole mask 1200B on a test reticle 1000A. More specifically, the second optical member 500 should be attached to the pinhole mask 1200B on the test reticle 1000A, or disposed in a pinhole 1200A.

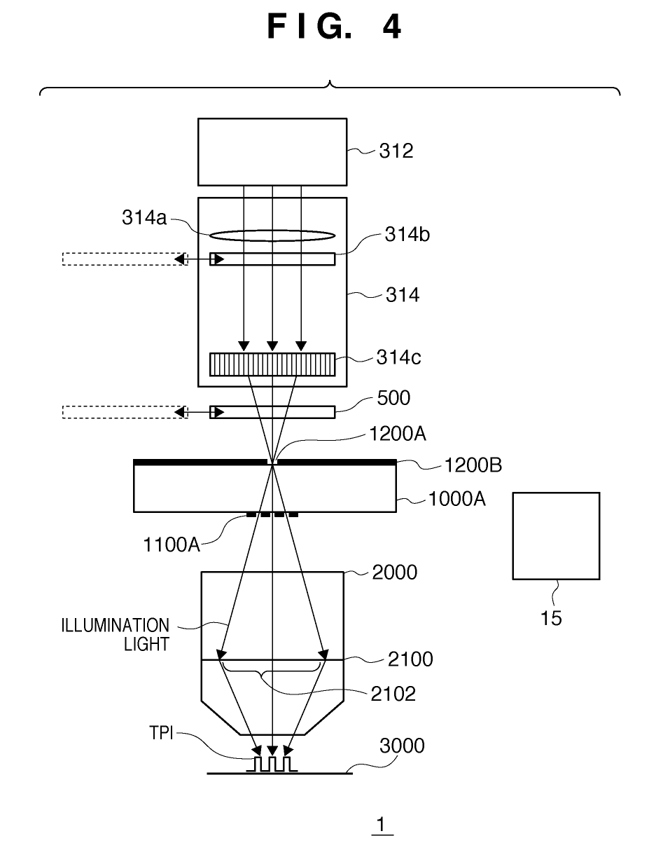

FIG. 4 is a view showing the schematic arrangement of an exposure apparatus or a measurement apparatus according to the second embodiment of the present invention. The second embodiment is different from the first embodiment in that the second optical member 500 is present between the illumination optical system 314 and the exit of the pinhole mask 1200B.

An illuminance distribution h(x, y) formed on an image plane 3000 of a projection optical system 2000 is given by:

h(x,y)=(f(x,y)·fy(x,y))*ph(x,y)*g(x,y)·p(x,y)·rs(x,y)·cos⁴θ (3)

where g(x, y) is the illuminance distribution formed by the second optical member 500.

Equation (3) is different from equation (1) in that the illuminance distribution g(x, y) formed by the second optical member 500 is newly introduced into convolution calculation. The second optical member 500 exerts an action corresponding to the convolution calculation on the exit light from the illumination optical system 314 to average a transmittance fy(x, y) of the fly-eye lens 314c. Thus, nonuniformity of the transmittance fy(x, y) is reduced. The second optical member 500 can include a binary optics or a diffusing plate.

The illuminance distribution g(x, y) formed by the second optical member 500 will be explained herein. The diameter of the pinhole 1200A is generally as small as, for example, about 100 to 200 μm. For this reason, the size and the number of cells of a binary optics which constitutes the second optical member 500 are limited. The smaller the number of cells, the greater the adverse effect that a manufacturing error of each cell inflicts on the illuminance distribution.

To overcome this situation, the illuminance distribution g(x, y) formed by the second optical member 500 can have a σ value as low as σ<0.3 for 70% or more of the illuminance, instead of being a complex distribution or a distribution with a wide angle of diffusion. The use of a low-σ illuminance distribution g(x, y) decreases the degree of difficulty of the fabrication of a binary optics. This allows a decrease in manufacturing errors.

Equation (3) can be solved assuming that g_{ideal}(x, y) is a low-σ illuminance distribution. As in the first embodiment, h_{ideal} (x, y) is substituted into the left side of equation (3), design values or actual measurement values of an illuminance distribution and transmittance distribution and the like are substituted into its right side, and deconvolution is performed. With this operation, f_{ideal}(x, y) can be obtained as an ideal f(x, y).

h_{ideal}(x, y) can be formed by light having passed through the first optical member 314b and second optical member 500.

If it is difficult to attain one or both of f_{ideal} (x, y) and g_{ideal} (x, y) calculated to implement h_{ideal} (x, y), the following method may be adopted. That is, a combination of f(x, y) and g(x, y) falling within practically possible ranges of values, with which h_{ideal} (x, y) satisfies a target illumination condition, may be determined.

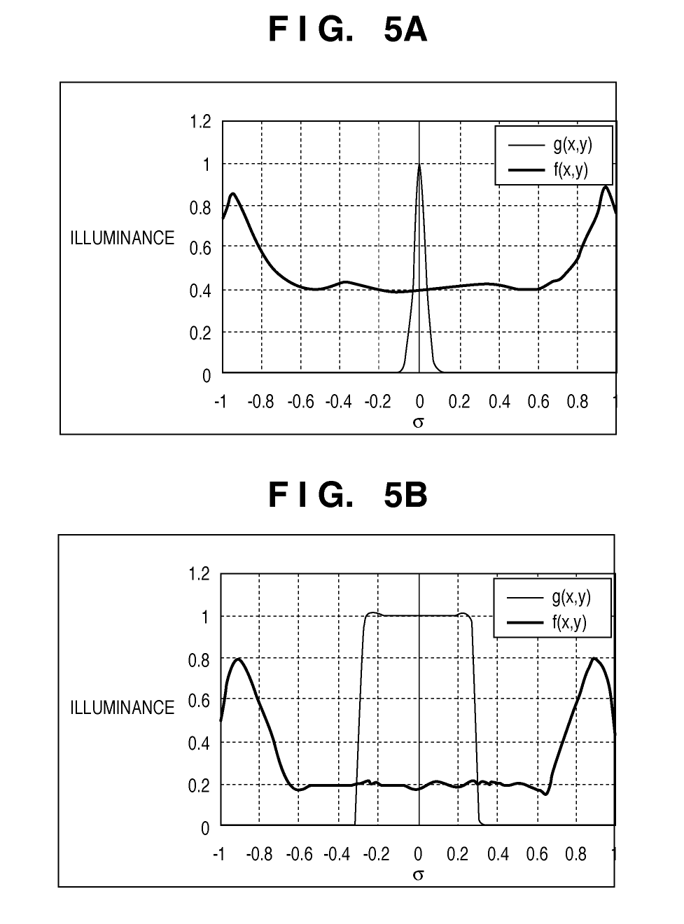

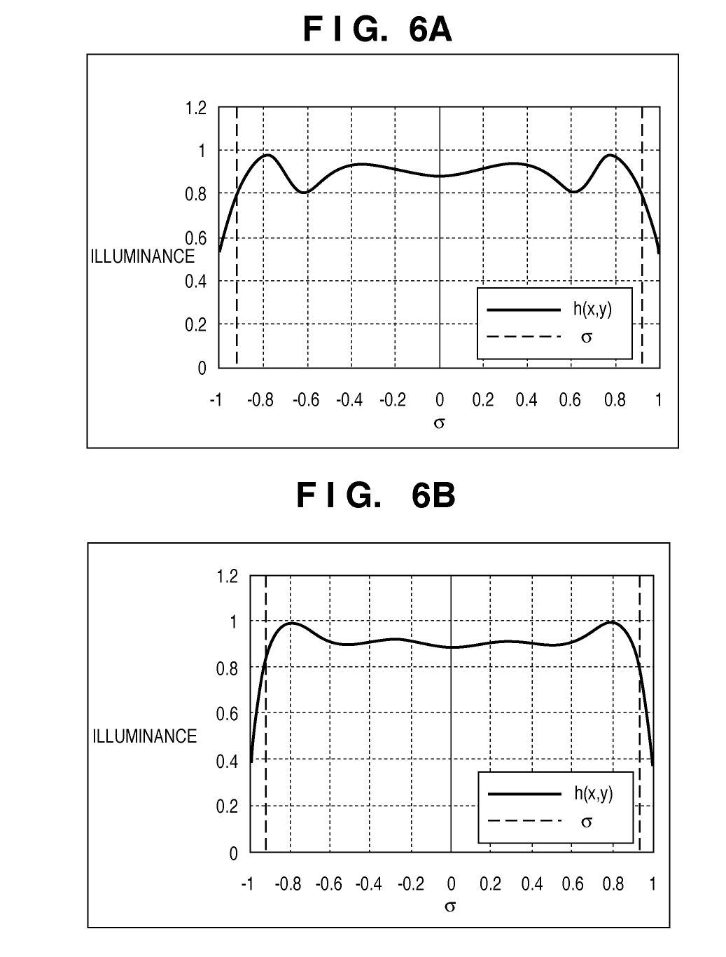

FIGS. 5A and 5B are graphs illustrating f(x, y) and g(x, y). FIG. 6A is a graph showing h(x, y) formed on the image plane using f(x, y) and g(x, y) illustrated in FIG. 5A. FIG. 6B is a graph showing h(x, y) formed on the image plane using f(x, y) and g(x, y) illustrated in FIG. 5B. Neither of these h(x, y) are uniform but they satisfy a target illumination condition.

### [Illumination Condition Optimization]

Illumination condition optimization (step 5111 in FIG. 10) in the exposure apparatus or the measurement apparatus according to each of the first and second embodiments will be described next.

FIG. 8 is a flowchart showing details of the illumination condition optimization process in step 5111 of FIG. 10. A controller 15 controls the process shown in FIG. 8.

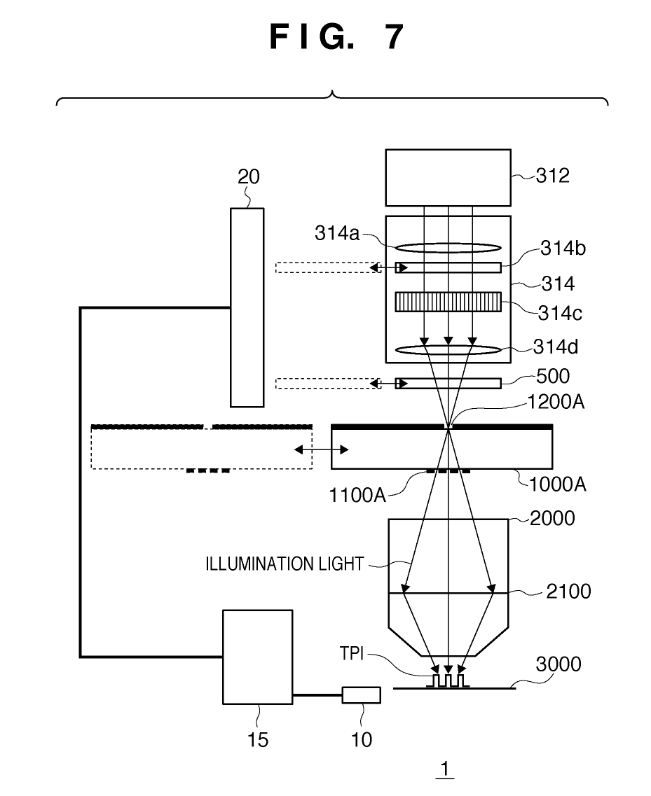

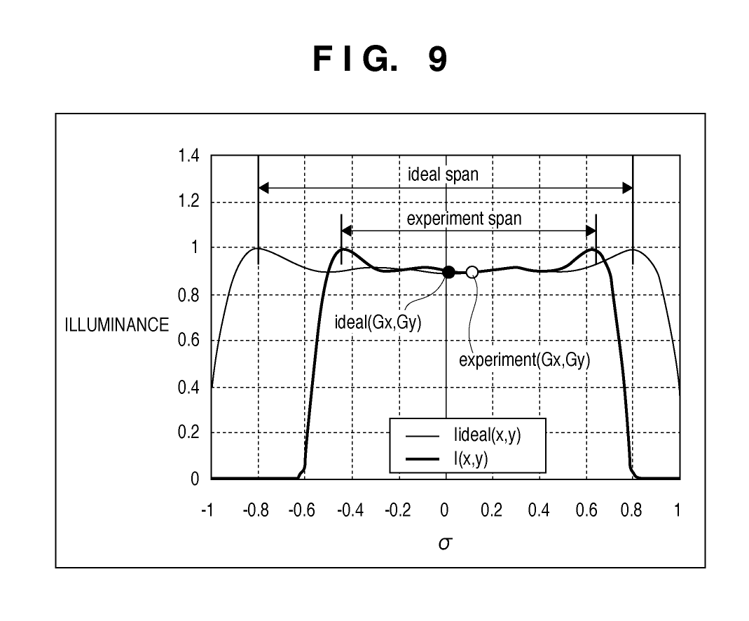

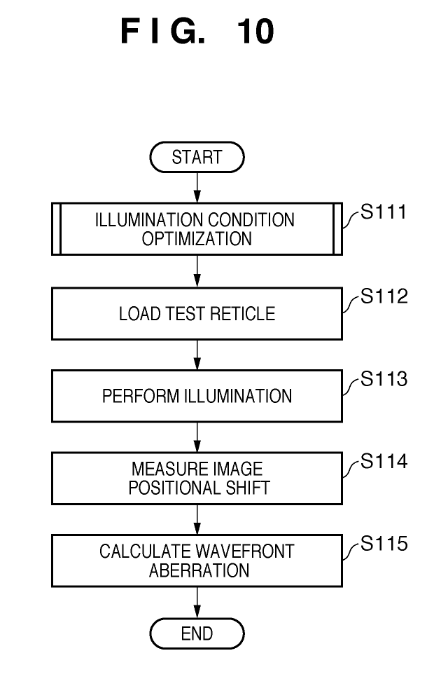

FIG. 7 is a view showing the arrangement of an exposure apparatus or a measurement apparatus according to an embodiment of the present invention. FIG. 7 shows a detector 10 and driving unit 20 as constituent elements involved in measurement of the wavefront aberration of a projection optical system 2000 as the measured optical system. Note that the detector 10 and driving unit 20 are not shown in FIGS. 1 and 4. FIG. 9 is a graph illustrating the illuminance distribution.

In step S120 (i.e., deposed first optical member), an optical member 314b is inserted in the optical path of an illumination optical system 314. At this time, taking account of subsequent barycentric position calculation, the positions of a first condenser lens 314a and second condenser lens 314d in the optical axis direction (i.e., their magnifications) are to be adjusted so that a stop or the like of the illumination optical system 314 does not eclipse an illuminance distribution formed by the optical member 314b.

In step S121 (i.e., measure illuminance distribution), light is supplied from a light source 312 to the illumination optical system 314. The light emerging from the illumination optical system 314 forms an illuminance distribution I(x, y) on an image plane 3000 via the projection optical system 2000. The illuminance distribution I(x, y) is detected by the detector 10. Note that a test reticle 1000A is not disposed in the optical path at this time.

The illuminance distribution I(x, y) detected by the detector 10 is given by:

I(x,y)=(f(x,y)·fy(x,y))*ph(x,y)·p(x,y)·cos⁴θ (4)

An ideal illuminance distribution I(x, y) calculated based on a design value is defined as an I_{ideal} (x, y) herein.

In step S122 (i.e., calculate illuminance barycenter/magnification), the controller 15 calculates a barycentric position (Gx, Gy) and the magnification of the illuminance distribution I(x, y). The barycentric position (Gx, Gy) is given by:

(Gx,Gy)=1/w*ΣΣI(x,y)·(x,y) (5)

As described above, when a stop or the like of the illumination optical system eclipses the illuminance distribution I(x, y), it is impossible to precisely calculate the barycenter in accordance with equation (5). To prevent this, the magnification of the illuminance distribution I(x, y) is to be adjusted to be able to measure the overall illuminance distribution I(x, y). In the example shown in FIG. 9, the barycenter of I_{ideal}(x, y) is ideal(Gx, Gy), and the barycenter calculated in accordance with equation (5) is experiment (Gx, Gy).

The magnification can be calculated as the ratio of the region corresponding to I(x, y) to that corresponding to σ=1, or as the ratio of the distribution region of I(x, y) to that of I_{ideal} (x, y) In the example shown in FIG. 9, the width of the characteristic distribution of I_{ideal}(x, y) is indicated by “ideal span”. Also, the interval across which the value in I(x, y) exhibits the same illuminance as that of the σ value which defines “ideal span” of I_{ideal} (x, y) is indicated by “experiment span”. The magnification can be calculated by, for example, “experiment span”/“ideal span”.

In step S123, the controller 15 checks whether or not the calculated barycentric position and magnification fall within a tolerance for I_{ideal} (x, y) If yes, the process is terminated. Otherwise, the process proceeds to step S124. The ranges of the barycenter and magnification of I(x, y), with which h(x, y) satisfies a target illumination condition, are to be simulated in advance as a tolerance. The relationships between I(x, y) and h(x, y) in the first and second embodiments are respectively given by:

h(x,y)=I(x,y) (6)

h(x,y)=I(x,y)*g(x,y) (7)

If the controller 15 determines that I(x, y) falls within the tolerance, it ends illuminance distribution optimization.

If the controller 15 determines that I(x, y) falls outside the tolerance, it calculates the adjustment amounts (i.e., barycenter and magnification adjustment amounts) of the positions (i.e., the magnifications) of the first condenser lens 314a and second condenser lens 314d based on the calculated barycentric position and magnification in step S124.

In step S125 (i.e., adjust barycenter magnification), the controller 15 causes the driving unit 20 to drive the first condenser lens 314a and second condenser lens 314d in accordance with the adjustment amounts calculated in step S124, and returns the process to step S121.

A case in which the measurement apparatus according to the present invention is configured to measure the wavefront aberration of an optical system having different NAs will be considered herein. In this case, the illuminance distribution can be adjusted by calculating the amount of change in magnification with respect to a reference magnification based on the ratio of the NA of the measured optical system to a reference NA, and adjusting the magnification of the illumination optical system using a magnification adjusting mechanism (including the first and second condenser lenses 314a and 314b).

The optical member 314b is insertable into and retractable from the illumination optical system 314. Hence, a plurality of exposure apparatuses or measurement apparatuses can form identical illuminance distributions using a common optical member 314b. Even when individual exposure apparatuses include projection optical systems that are the measured optical systems and have different NAs, they each can adjust the illuminance distribution by adjusting the magnification using a magnification adjusting mechanism.

The wavefront aberration can be measured with a suitable illuminance distribution by executing the above-mentioned illuminance distribution optimization in step S111 in the wavefront aberration measurement shown in FIG. 10. Thus, the wavefront aberration measurement accuracy improves. When a variation in illuminance distribution falls within a tolerable level, there is no need to execute step S111 for each wavefront aberration measurement.

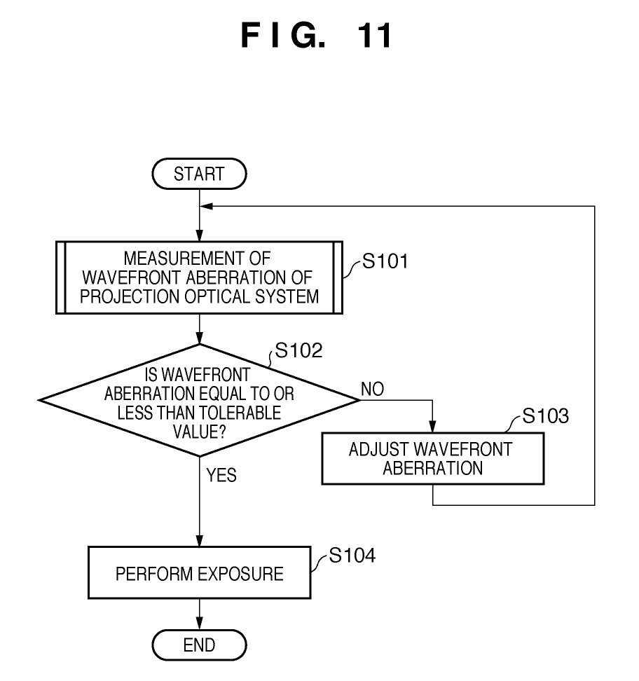

FIG. 11 is a flowchart showing a control method for an exposure apparatus according to an embodiment of the present invention. A controller 15 controls the process shown in FIG. 11. In step S101, the wavefront aberration measurement (e.g., of the projection optical system) shown in FIG. 10 is performed. In step S102, the controller 15 checks whether or not the measured wavefront aberration is equal to or less than a tolerable value. If the measured wavefront aberration is equal to or less than the tolerable value, the process advances to step S104 (i.e., perform exposure), in which the exposure apparatus exposes one or a plurality of substrates. On the other hand, if the measured wavefront aberration exceeds the tolerable value, the controller 15 drives an optical element of a projection optical system 2000 to adjust the wavefront aberration in step S103.

A device manufacturing method according to an embodiment of the present invention can be performed to manufacture devices such as a semiconductor device and a liquid crystal device. The method can include a step of exposing a substrate coated with a photosensitive agent using the exposure apparatus, and a step of developing the exposed substrate. The device manufacturing method can also include known subsequent steps (e.g., oxidation, film formation, vapor deposition, doping, planarization, etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-282435, filed Oct. 31, 2008, which is hereby incorporated by reference herein in its entirety.

What is claimed is:

1. A measurement apparatus for measuring wavefront aberration of an optical system to be measured, the apparatus comprising:
a pinhole mask having a pinhole;
an illumination optical system configured to illuminate the pinhole mask;
a test pattern disposed between the pinhole mask and the optical system to be measured;
a detector configured to detect an image formed on an image plane of the optical system to be measured by light having passed through the pinhole, the test pattern, and the optical system to be measured; and
an optical member which is disposed or inserted in the illumination optical system, and configured to control an illuminance distribution in a pupil region of the optical system to be measured so that a peripheral portion in the pupil region includes a portion having an illuminance higher than an illuminance in a central portion in the pupil region.

2. The apparatus according to claim 1, wherein the optical member includes a binary optics.

3. The apparatus according to claim 1, further comprising:
a second optical member disposed or inserted between the illumination optical system and an exit of the pinhole,
wherein the second optical member is configured to reduce nonuniformity of a transmittance distribution of an optical element disposed in the illumination optical system.

4. The apparatus according to claim 3, wherein the second optical member includes one of a binary optics and a diffusing plate.

5. The apparatus according to claim 3, wherein the second optical member is disposed inside or near the pinhole.

6. The apparatus according to claim 1, wherein the optical member controls the illuminance distribution formed in the pupil region of the optical system to be measured so that the illuminance distribution in the pupil region has a peak in the peripheral portion.

7. An exposure apparatus for projecting a pattern of a reticle onto a substrate by a projection optical system to expose the substrate, the apparatus comprising:
a measurement apparatus configured to measure wavefront aberration of the projection optical system, the measurement apparatus comprising:
a pinhole mask having a pinhole;
an illumination optical system configured to illuminate the pinhole mask;
a test pattern disposed between the pinhole mask and the projection optical system;
a detector configured to detect an image formed on an image plane of the projection optical system by light having passed through the pinhole, the test pattern, and the projection optical system; and
an optical member which is disposed or inserted in the illumination optical system, and configured to control an illuminance distribution in a pupil region of the projection optical system so that a peripheral portion in the pupil region includes a portion having an illuminance higher than an illuminance in a central portion in the pupil region.

8. A device manufacturing method comprising the steps of:
exposing a substrate by an exposure apparatus; and
developing the substrate,
wherein the exposure apparatus is configured to project a pattern of a reticle onto the substrate by a projection optical system to expose the substrate, and comprises
a measurement apparatus configured to measure wavefront aberration of the projection optical system, the measurement apparatus comprising:
a pinhole mask having a pinhole;
an illumination optical system configured to illuminate the pinhole mask;
a test pattern disposed between the pinhole mask and the projection optical system;
a detector configured to detect an image formed on an image plane of the projection optical system by light having passed through the pinhole, the test pattern, and the projection optical system; and
an optical member which is disposed or inserted in the illumination optical system, and configured to control an illuminance distribution in a pupil region of the projection optical system so that a peripheral portion in the pupil region includes a portion having an illuminance higher than an illuminance in a central portion in the pupil region.
